(19) United States
(12) Patent Application Publication
(10) Pub. No.: US 2017/0321938 A1
(43) Pub. Date: Nov. 9, 2017

(54) METHOD AND SYSTEM FOR RECOVERING COOLANT GAS IN AN AIR CONDITIONING SYSTEM

(71) Applicant: BRAIN BEE S.p.A., Parma (IT)

(72) Inventor: Andrea CANTADORI, Parma (IT)

(21) Appl. No.: 15/481,760

(22) Filed: Apr. 7, 2017

(30) Foreign Application Priority Data
Apr. 7, 2016 (IT) UA2016A002396

(51) Int. Cl. F25B 45/00; B60H 1/00; F25B 43/00; F28D 21/00

(52) U.S. Cl. CPC F25B 45/00; F25B 43/00; F28D 21/0003; B60H 1/00585; F25B 2345/001; F28D 2021/0028; F25B 2345/002

(57) ABSTRACT

A method and corresponding system for extracting an unsuitable and/or unknown and/or contaminated coolant gas from an air conditioning system. An existing coolant fluid recovery/charging machine is used in order to extract the heat required to cool said containment element of the coolant to be extracted or extracted.

### SCOPE OF THE INVENTION

The present invention relates to the field of coolant recovery apparatuses in air conditioning systems of a vehicle.

### PRIOR ART

In order to protect the environment by reducing the greenhouse effect, the law relating to air conditioning systems in vehicles (European Directive 2006/40/EC) requires the use of coolants only with GWP (Global Warming Potential) index of at most 150.

The R134a gas commonly used today has a GWP index of 1430, thus a high potential of impact on the greenhouse effect, therefore the use of a new coolant called R1234yf, which has a GWP of 4, is spreading.

In particular, said R1234yf has been used on newly registered vehicles since 2011 and from 2017 onwards, it will not be possible anymore to introduce into the market vehicles with systems using the R134a gas.

However it is estimated that, by that date, about 60% of the European circulating vehicles will still be equipped with R134a gas; therefore, there will be the need to change said gas by replacing it with the approved one.

In addition, it should also be mentioned that there is a relevant portion of the circulating vehicles that still uses gas having unknown or otherwise unsuitable composition, such as propane, which incidentally is highly flammable.

Therefore, there is the need to develop a methodology for addressing the problem of how to proceed with the maintenance of the air conditioning system of motor vehicles, and in particular with charging the coolant, if:
the coolant is not of the approved type, but the coolant used before the regulations on the use of R1234yf,
the coolant is of unknown type.

Identifying systems are known which are configured to analyze and identify whether the type of coolant present in the vehicle air conditioning system is known or unknown, or in general “contaminated”.

If there is a mixture of coolants or of substances which are unknown or difficult to identify, the operating protocol provides to carry out the extraction of the “contaminated” coolant without the aid of the so-called “air conditioning service units” which normally used in workshops because they are coolant recovery and charging machines and which consist of a recovery unit, a hydraulic suction/introduction circuit and an electrical system.

These components would make the extraction highly dangerous, or at least not safe to the operator.

The need is therefore felt to extract safely the “contaminated” coolant from the vehicle air conditioning system and only after that to reintroduce the approved coolant, currently R1234yf.

A method currently employed provides for connecting the air conditioning system of the car to an external auxiliary container, such as a tank, in turn immersed in a fluid at low temperature, such as dry ice (solid state carbon dioxide obtained when the temperature reaches −78° C.).

At that point, the gas present within the vehicle air conditioning system moves into the auxiliary tank and condensates.

However, the applicant finds many drawbacks in the use of the coolant gas extraction system and method in vehicle air conditioning systems by means of dry ice for condensation.

A first drawback is to find of the material, its transport and especially storage; this would require the use of refrigerating rooms and a suitable and dedicated equipment, hardly available in workshops.

A second drawback is that of the very strict implementation of usage measures, requiring the need for gloves and suitable protection for working with dry ice.

Last but not least, a third drawback is related to the inhalation of CO₂, which in high concentrations produces toxic effects and may cause permanent damage. In fact the regulations require levels of security designed to keep the dry ice to below 1%, in order to have light effects on metabolism even after an exposure of several hours.

For specific uses, it is calculated that at least 300 m³ air would be needed to dispose of the amount of dry ice needed to cool the tank containing the “contaminated” coolant.

### DESCRIPTION AND ADVANTAGES OF THE INVENTION

An object of the present invention is to provide an improved method for recovering only the unsuitable and/or “contaminated” coolant present in a cooling circuit of air conditioning systems of vehicles, with a safe, cost-effective solution that does not contemplate the use of dry ice.

In addition, the methodology requires little maintenance and it is easily implementable by workshop operators, without requiring a higher degree of specialization.

These and other objects are achieved by the features of the invention as described in the independent claims. The dependent claims describe preferred and/or particularly advantageous aspects of the invention.

In particular, an embodiment of the present invention provides a method for extracting gas coolant that is unsuitable and/or unknown and/or contaminated, of an air conditioning system, configured to perform the extraction of said gas in a dedicated containment element and with at least one cooling step of the extracted gas, wherein it is provided for using an existing coolant fluid charging/recovery machine in order to extract the heat required to cool said containment element of the coolant to be extracted or recovered.

More specifically, by suitably connecting the above machine available in the workshop for the indicated operations, i.e. by connecting it to said containment element so as to form a closed circuit, in particular a refrigerating closed circuit, it is extracted the heat required to cool said containment element and thus the coolant to be extracted or recovered.

Owing to this solution, it is extremely convenient and easy to implement the connection and the use of the coolant contained in the existing coolant fluid recovery/charging machine; in fact, few connections and easy configuration are required to establish an external refrigerating circuit that requires no electrical connections directly associated with the vehicle air conditioning system, preserving the operators' safety during this extraction.

Based on a further aspect, the method provides that the refrigerating circuit may be excluded while keeping the existing machine connected; in this way, opening a bypass passage (and closing at the same time a lamination member configured to produce the evaporation of the coolant fluid) it is possible to heat the container, thanks to the fluid that now passes within, and almost at room temperature, a heat exchanger placed for example in the containment element of the gas to be extracted or recovered.

With this solution, the pressure rises and facilitates the transfer of the extracted coolant towards the outlet and thus the collection of the extracted coolant to be then disposed of from a further container, preferably placed underneath so as to facilitate the discharge by gravity.

Another object of the invention is a system consisting of at least one containment element for “contaminated” gases, comprising at least two connectors for the connection with the vehicle's air conditioning system, a heat exchanger inside connected to branches of an open circuit that can be connected at the ends thereof with respective high and low pressure ports of a recovery/charging machine of known type, and use the coolant thereof for cooling the containment element. On the branch connectable to the high pressure end of the machine it is provided a lamination member adapted to lower the pressure of the coolant circulating in the circuit and to cause the evaporation thereof. A bypass branch is also provided to exclude keep the above coolant circulating even with closed valve and to cause the heating of the previously cooled cylinder.

Said objects and advantages are all achieved by the method and system for recovering coolant gas from an air conditioning system by an external containment element, object of the present invention, which is characterized by the appended claims.

### BRIEF DESCRIPTION OF THE FIGURES

This and other features will become more apparent from the following description of some of the configurations, illustrated purely by way of example in the accompanying drawing.

FIG. 1: schematically shows the system and device for extracting contaminated gases from an air conditioning system of vehicles, according to the invention.

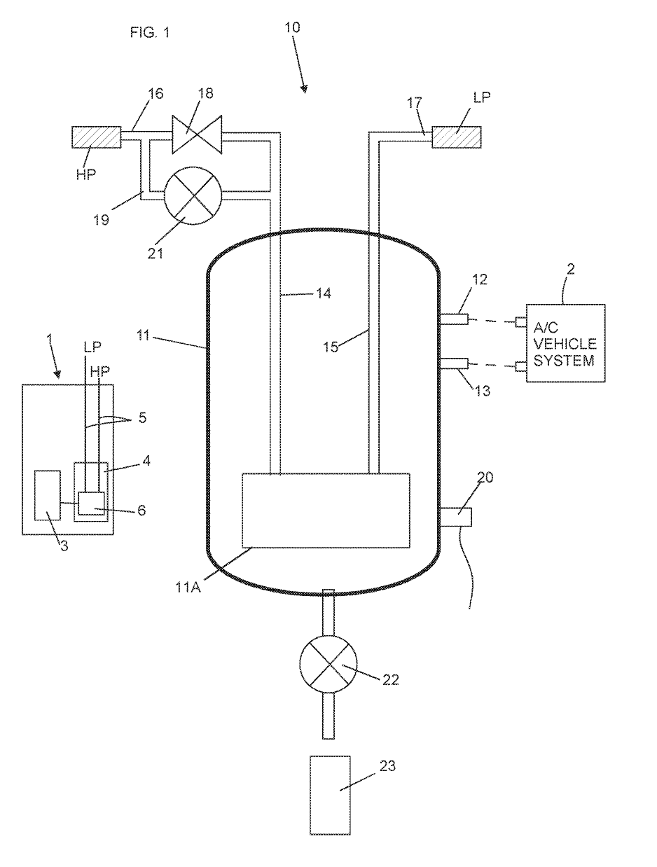

### DESCRIPTION OF THE INVENTION

Normally, the technical term of “climate stations” or “charging station” refers to machines for charging/recovering a coolant fluid in/from an air conditioning system of a vehicle.

With reference numeral 1 it is indicated a generic charging station of an air conditioning system 2, such as a car, a truck, a bus or any other similar land vehicle with engine. The station basically consists of a frame, preferably provided with ground support wheels for easy movement thereof, a user control interface adapted to impart controls to the charging station 1, at least one tank 3 for containing the coolant fluid, a suction/introduction unit 4, which can be connected on one end to said tank 3 and on the other end, to a pair of relative high pressure conduits 5 that allow high pressure connection HP, in which the liquid high pressure coolant circulates, and a low pressure connection LP, in which the coolant is in a gaseous state and at low pressure.

The above suction/introduction unit 4 is also associated to a suction unit 6 which, for example through a compressor element, draws/extracts (in other words, circulates in the associated circuit) the coolant in the closed circuit which is normally established with the air conditioning system 2.

The present invention instead implements an efficient connection of said suction/introduction unit 4 to an auxiliary containment element, hereinafter indicated with reference numeral 11, so as to fully implement the extraction method of a “contaminated” gas from the conditioning system 2 of the vehicle.

The cooling steps can be conveniently managed by the data control and processing unit/card configured to manage not only the normal charging/recovery steps but also the sequence of operations required by the present method and connection system, in order to implement the present invention.

Again with reference to the FIGURES, reference numeral 10 globally indicates the extraction/recovery system of unsuitable or contaminated gases from the air conditioning system 2.

System 10 comprises the containment element 11, sealed and thermally insulated and configured to receive the “contaminated” gas from the air conditioning system 2.

In that regard, the containment element 11 has at least two couplings 12, 13 for the quick connection with relevant couplings on the air conditioning system 2, i.e. those normally used for connecting the charging station 1.

Within said containment element 11 there are one or more heat exchangers 11A in turn connected to two branches 14, 15 of an open circuit that can be connected at ends 16 and 17 thereof to the already mentioned high pressure HP, and low pressure LP ports of the recovery/charging machine 1.

In this way, once branches 14, 15 have been coupled to ports HP and LP, a closed circuit is established with the introduction/recovery unit 4 described above.

It follows that the coolant fluid contained in tank 3 is now connected to the circuit of system 10.

Activating the compressor of the charging unit 1 will recirculate the coolant fluid inside system 10, entering through port HP, then in the exchanger 11A, to then flowing out through port LP.

In particular, the method involves using this coolant fluid for cooling the containment element 11. This takes place since at least one lamination member 18 is provided on the branch connectable to the high pressure end HP of station 1, configured to lower the pressure of the coolant circulating therethrough and to cause the evaporation thereof.

As will be better specified hereinafter in the description of the operation of the present extraction process, it is noted that a bypass branch 19 is also provided, which excludes valve 18 when the same is closed, keeping circulating the coolant of station 1.

The containment element 11 is preferably a 6 liter capacity tank, thermally insulated.

System 10 further comprises a probe 20 for detecting the temperature of element 11, associated with it, and which can be connected to a control unit preferably installed on the charging station in order to monitor, also through its interface, the progress during the extraction, cooling and heating steps.

The term extraction device claims the set of components described above that participate in the implementation of the system and that are not part of the existing charging unit 1. In detail, the extraction device consists of the tank or containment element 11, having ports for the connection with the system, and of the open circuit configured for coupling with the existing unit 1, implemented so as to connect externally to unit 1 and internally to element 11 to establish the heat exchange condition.

For example, in the circuit formed by branches 14 and 15 it is depicted entering into the containment body or element 11, however they may be arranged adjacent to its inner walls or to the outer walls or in other position adapted to establish in any case the direct or indirect cooling of the contaminated coolant extracted and contained in the containment element 11.

Operation

The present invention provides a method for recovering the coolant gas of an air conditioning system, particularly gases deemed as “unknown” or in any case not suitable to be safely treated with known charging stations such as those indicated and described with reference numeral 1.

In particular, the method carries out the extraction in a dedicated containment element of the “contaminated” or unknown or dangerous gas contained in the air conditioning system 2.

The method involves at least the cooling of the extracted gas in order to facilitate the extraction thereof.

Generically, once system 10 has been connected to the existing charging unit 1, heat is extracted, required to cool the containment element 11 of the coolant (to be extracted or already extracted) using the coolant of the existing recovery/charging machine 1.

Of course, as said, this is possible when the recovery/charging machine 1 is connected to said containment element 11 so as to form a closed circuit for circulating the coolant by the introduction unit 4.

According to the invention, said closed circuit is of refrigerating type, due to the presence of a lamination member 18 in system 10 object of the invention.

According to another aspect of the invention, said closed circuit of refrigerating type can be excluded through a bypass branch; in this configuration, the containment element 11 and thus the gas can be heated, thus promoting the subsequent discharge thereof.

As it is apparent from the foregoing, the closed circuit can be implemented by connecting respective ends of a heat exchanger placed within the containment element with respective high and low pressure (HP and LP) ports of said recovery/charging machine.

System 10 has no electrical connections, but only two quick connections for coupling with the air conditioning system 2 and only two connections/ports for connecting to the respective high and low pressure ports (HP, LP) of the existing unit 1.

Operating Steps
Once both the existing unit 1 and the air conditioning system 2 have been connected to system 10, as indicated above, it is provided for starting the cooling step by commanding to the existing unit 1 to start its introduction unit 4: the coolant charge starts from station 1 to system 10 through port HP and its recovery from port LP.
Passing through the lamination valve 18, the coolant lowers its pressure to 1 bar (14.5 psi) and begins to evaporate and cool to −30° C. (−22° F.) before being recovered on the LP end.
The “contaminated” or unknown coolant enters from the air conditioning system 2 towards the containment element 11 through dedicated couplings to which it is connected.
The “contaminated” or unknown coolant begins to cool and condensate on the bottom of the containment element 11.
It is provided to monitor, for example by means of the same unit 1, the temperature of the containment element 11 until it is steady at least at −20° C. (−4° F.) and for an extent of time in the range of 8-12 minutes.
At this point, the recovery/extraction process is complete.
At this point, the lamination member can be closed and the bypass opened by the respective valve 21; the coolant of unit 1 continues to flow but this time it is used to cause the heating of element 1 to room temperature. While heating, the container pressure rises, thereby facilitating the subsequent extraction of the recovered coolant.
By acting on the extraction valve 22, said recovered coolant is discharged by gravity, preferably introduced in a dedicated disposal container 23.

It is clear that several changes and/or additions of parts may be made to the extraction apparatus and relevant system and method described herein without departing from the scope of the present invention. It is also clear that while the present invention has been described with reference to some specific examples, a man skilled in the art can certainly implement many other equivalent embodiments of apparatus and relevant method, having the features set forth in the claims, and thus all falling within the scope of protection defined by them.

1. Method for recovering coolant gas in an air conditioning system, which is of the type adapted to carry out the extraction of the gas in a suitable containment element and which provides at least one cooling step for cooling the extracted gas, providing for extracting the heat required to cool said containment element of the coolant to be extracted or extracted using the coolant contained in an existing coolant fluid recovery/charging machine, when said recovery/charging machine is connected to said containment element so to form a closed circuit, and then for heating the containment element before emptying the same.

2. Method according to claim 1, wherein said closed circuit is of refrigerating type.

3. Method according to claim 1, wherein it is provided for establishing said closed circuit by connecting respective ends of a heat exchanger placed within the containment element with respective high and low pressure ports of said recovery/charging machine.

4. Method according to claim 1, wherein it is provided for monitoring the temperature of the containment element until it is steady at least at −4° F. and for an extent of time in the range of 8-12 minutes.

5. Method according to claim 1, wherein it is provided for emptying the containment element of the extracted coolant by transferring said extracted coolant into a dedicated disposal container.

6. Method according to claim 5, wherein the extracted coolant is transferred into the dedicated disposal container by gravity.

7. Method according to claim 1, wherein said heating the containment element is carried out by excluding the refrigerating closed circuit.

8. Method according to claim 7, wherein the refrigerating circuit is excluded by means of the passage of the coolant in a bypass branch.

9. System for recovering/extracting contaminated unsuitable gases from an air conditioning system, comprising at least one containment element, hermetically sealed and thermally insulated, configured to receive said unsuitable gas, wherein the containment element has at least two couplings for quick connection with corresponding couplings provided on the air conditioning system, one or more heat exchanger elements provided into said containment element and in turn connected to two branches connectable at ends thereof with high pressure port and low pressure port, respectively, of a recovery/charging machine, wherein at least one lamination member is provided between one of the two branches and the end, wherein once the branches have been coupled with the high pressure port and the low pressure port of the recovery/charging machine, a closed circuit with the recovery/charging machine itself is formed and a coolant fluid contained in the tank of the unit can be introduced into the system.

10. System for recovering/extracting contaminated unsuitable gases according to claim 9, comprising a switching valve and a bypass branch which connects the branch to the end and which is configured to bypass the lamination valve when the switching valve is open.

11. System for recovering/extracting contaminated unsuitable gases according to claim 10, comprising at least one dedicated disposal container connected to the containment element through an extraction valve and configured to receive the extracted coolant when the switching valve is closed the fluid passes through the lamination member, and the extraction valve is open.
